(19) United States
(12) Patent Application Publication
(10) Pub. No.: US 2008/0255721 A1
(43) Pub. Date: Oct. 16, 2008

(54) On-vehicle data collection apparatus, center, and on-vehicle system

(75) Inventor: Mitsuo Yamada, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/081,166

(22) Filed: Apr. 11, 2008

(30) Foreign Application Priority Data
Apr. 13, 2007 (JP) 2007-105700

(51) Int. Cl. G01M 17/00; G06F 3/06

(52) U.S. Cl. 701/33

(57) ABSTRACT

In a data collection apparatus mounted on a vehicle, an electric control unit sets an abnormality detection condition to detect abnormality of the vehicle based on a condition signal received from an external apparatus located outside the vehicle. The electric control unit determines whether the detection condition is satisfied and stores vehicle control data or vehicle behavior data upon satisfaction of the detection condition as freeze data. The abnormality of the vehicle is analyzed using the freeze data.

### CROSS REFERENCE TO RELATED APPLICATION

This application is based on and incorporates herein by reference Japanese Patent Application No. 2007-105700 filed on Apr. 13, 2007.

### FIELD OF THE INVENTION

The present invention relates to an on-vehicle data collection apparatus that stores data indicating behavior of a vehicle or control of the vehicle, relates to a center communicating with the data collection apparatus, and relates to an on-vehicle data collection system constructed with multiple data collection apparatus.

### BACKGROUND OF THE INVENTION

Conventionally, a data collection apparatus is known that has a function to detect a failure of sensors and actuators mounted to a vehicle, and with the detection of the failure as a trigger, stores data indicating the behavior of the vehicle before and after the failure or data indicating the control of the vehicle as freeze data. The freeze data is used to determine the cause of a failure of the vehicle at a dealer or the like of the vehicle.

JP-A-H9-126954 discloses a technology of an apparatus that records vehicle data at the timing of receiving a specific trigger signal outputted by an apparatus outside the vehicle, as technology for facilitating the determination of the cause of failure by increasing the freedom of the timing of storing freeze data. However, the technology disclosed in JP-A-H9-126954 merely outputs a trigger signal to an external device at the timing of storing freeze data, but cannot complicatedly (i.e., flexibly) set the timing of recording freeze data from outside the vehicle.

### SUMMARY OF THE INVENTION

In view of the above-described problem, it is an object of the present invention to provide an on-vehicle data collection apparatus in which timing of storing data indicating behavior of a vehicle or control of the vehicle is flexibly set from outside the vehicle, to provide a center communicating with the data collection apparatus, and to provide an on-vehicle system constructed with multiple data collection apparatus that work in conjunction with each other.

According to a first aspect of the present invention, a on vehicle data collection apparatus includes a communication device configured to communicate with an external apparatus located outside the vehicle, a storage medium configured to hold data stored therein even after power supply to the data collection apparatus from outside the data collection apparatus is interrupted, a setting device configured to receive a condition signal from the external apparatus through the communication device and configured to set a condition contained in the condition signal as a detection condition to detect abnormality of the vehicle, and a freeze device configured to determine whether the detection condition is satisfied. The freeze device stores at least one of vehicle control data related to control of the vehicle and vehicle behavior data related to behavior of the vehicle in the storage medium as freeze data upon satisfaction of the detection condition.

According to a second aspect of the present invention, a center includes a communication interface configured to communicate with multiple data collection apparatus, an abnormality recording device configured to record vehicle identification information and vehicle failure information for each vehicle equipped with the data collection apparatus, an abnormality frequency determining device configured to determine a group of the same type of vehicles based on the vehicle identification information and configured to determine whether there is a failure type occurring in a larger number of vehicles than a reference occurrence rate in the group, based on the vehicle failure information, a correspondence relationship storage medium configured to store correspondence data between the data collection apparatus and the vehicle identification information of the vehicle equipped with the data collection apparatus, and a condition signal transmitting device configured to determine the data collection apparatus mounted to the vehicles belonging to the group based on the correspondence data and configured to transmit same condition signals to the data collection apparatus upon determination that there is the failure type occurring in a larger number of vehicles than the reference occurrence rate.

According to a third aspect of the present invention, an on-vehicle system includes a first communication apparatus configured to detect abnormality of a vehicle and coupled to an in-vehicle communication network and multiple second communication apparatus, each of which is coupled to the network and configured to communicate with the first communication apparatus through the network. The first communication apparatus transmits abnormality notice information indicative of the detected abnormality over the network upon detection of the abnormality Each second communication apparatus receives the abnormality notice information and determines whether the abnormality notice information is related to itself based on predetermined information. Each second communication apparatus stores the abnormality notice information together with at least one of vehicle control data and vehicle behavior data as freeze data in a storage medium upon determination that the abnormality notice information is related to itself. The storage medium holds data stored therein even after power supply to the system from outside the system is interrupted.

### BRIEF DESCRIPTION OF THE DRAWINGS

The above and other objectives, features and advantages of the present invention will become more apparent from the following detailed description made with check to the accompanying drawings. In the drawings:

FIG. 1 is a schematic diagram showing an overall construction of a vehicle system 100 of a first embodiment of the present invention and its peripheral devices;

FIG. 2 is a block diagram showing an outline of an internal construction of CPU 1b;

FIG. 3 is a timing chart showing an example of abnormality determining criteria of an abnormality determining unit 16;

FIG. 4 is a timing chart showing an example of abnormality in a port that cannot be detected by the abnormality determining unit 16;

FIG. 5 is a flowchart showing processing contents of trigger setting process 17b executed by a control unit 17;

FIG. 6 is a drawing showing an example of a data structure of a RAM condition signal 40;

FIG. 7 is a drawing showing an example of a data structure of a port condition signal 50;

FIG. 8 is a drawing showing example of a data structure of a pattern condition signal 60;

FIG. 9 is a flowchart of arbitrary setting processing executed by a control unit 17;

FIG. 10 is a drawing showing an example of a structure of a RAM pattern notice signal 420 transmitted by the control unit 17 to indicate a registration pattern number;

FIG. 11 is a drawing showing an example of a structure of a port pattern notice signal 430 transmitted by the control unit 17 to indicate a registration pattern number;

FIG. 12 is a flowchart of pattern selection processing executed by the control unit 17;

FIG. 13 is a timing chart showing a case where an abnormality undetectable by the abnormality determining unit 16 is detected by freeze process 17a;

FIG. 14 is a schematic diagram showing the construction of a management center 250 of a second embodiment of the present invention;

FIG. 15 is a diagram showing the data structure of a failure information DB;

FIG. 16 is a flowchart of processing executed by a CPU 254;

FIG. 17 is a flowchart showing an example of a procedure for analyzing vehicle failure by an operator;

FIG. 18 is a drawing showing a data structure of a RAM pattern request signal 410 that requests a pattern condition;

FIG. 19 is a drawing showing a data structure of a port pattern request signal 440 that requests a pattern condition;

FIG. 20 is a drawing showing the respective operations of ECUs 1-4 in a fourth embodiment and the correlation among the operations;

FIG. 21 is a drawing showing a data structure of an abnormality notice signal 450 including a diagnosis code; and

FIG. 22 is a drawing showing a data structure of an abnormality notice signal 460 including a pattern number.

### DETAILED DESCRIPTION OF THE PREFERRED EMBODIMENTS

### First Embodiment

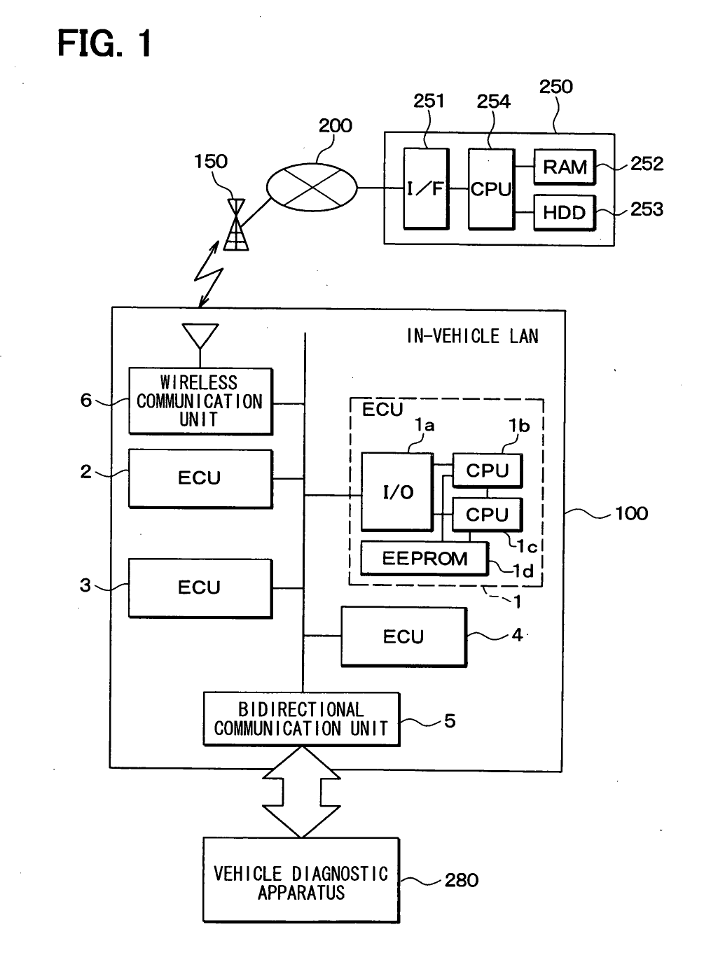

FIG. 1 schematically shows an overall construction of a vehicle system 100 according to a first embodiment of the present invention and its peripheral devices. The vehicle system 100 is mounted on a vehicle. The vehicle system 100 can exchange signals with a vehicle diagnostic apparatus 280 outside the vehicle. The vehicle system 100 can communicate with a distant management center 250, for example, via a base station 150 and a network 200 (e.g., a wide area network (WAN) such as the Internet, leased line, or the like).

As shown in FIG. 1, the vehicle system 100 includes various types of electronic control units (ECUs) 1-4 to control actuators (not shown in the drawing) mounted on the vehicle and obtain states of the vehicle by using sensors (not shown in the drawing) mounted on the vehicle. Further, the vehicle system 100 includes a bidirectional communication unit 5 and a wireless communication unit 6. The bidirectional communication unit 5 mediates the exchange of signals between the vehicle diagnostic apparatus 280 and the ECUs 1-4, and the wireless communication unit 6 mediates communications between the ECUs 1-4 and the base station 150. The ECUs 1-4, the bidirectional communication unit 5, and the wireless communication unit 6 communicate with each other via a communication line and constitute an in-vehicle local area network (LAN).

The ECU 1 includes an input/output (I/O) interface unit 1a, an electrically erasable and programmable read only memory (EEPROM) 1d, and central processing units (CPUs) 1b, 1c. The I/O interface unit 1a mediates communications through the in-vehicle LAN between the CPUs 1b, 1c, and other devices. The CPUs 1b, 1c perform processing for controlling the actuators, processing for obtaining vehicle states, and processing for communication with other devices through the in-vehicle LAN. The EEPROM 1d is a well-known recording medium and can hold information even after power supply to the vehicle system 100 is interrupted.

Like the ECU 1, the ECUs 2-4 include a CPU and an I/O interface unit. Each of the ECUs 1-4 can have any number of CPUs except zero.

The vehicle diagnostic apparatus 280 sends and receives signals to and from each of the ECUs 1-4 via the bidirectional communication unit 5. Such a vehicle diagnosing device is generally used to extract failure-related information of the vehicle at vehicle dealers or the like. For example, the vehicle diagnostic apparatus 280 can include a user interface (not shown) that allows a user to operate the vehicle diagnostic apparatus 280, a control unit (not shown) that generates a signal indicating the user's operation, and a communication interface (not shown) that transmits the signal generated by the control unit to the ECUs 1-4 via the bidirectional communication unit 5. Upon reception of a signal transmitted from the ECUs 1-4 via the bidirectional communication unit 5, the communication interface outputs the received signal to the control unit. Upon receipt of the signal outputted from the communication interface, the control unit causes a display unit (not shown) to display information indicated by the received signal and/or causes a memory device (not shown) to store the information.

The signal transmitted based on the user's operation from the vehicle diagnostic apparatus 280 to the CPUs 1-4 of the vehicle system 100 includes a diagnosis code request signal for requesting a diagnosis code, a freeze data request signal for requesting freeze data, and a condition signal. The diagnosis code is a classification code representing a type of failure of the ECUs 1-4. The freeze data and the condition signal are described later.

The vehicle diagnostic apparatus 280 can recognize ECU configuration (e.g., the number of ECUs, types of ECUs, or the like) of the vehicle system 100 as follows. For example, the ECU configuration can be inputted to the vehicle diagnostic apparatus 280 by the user before communication between the vehicle diagnostic apparatus 280 and the vehicle system 100. Alternatively, the vehicle diagnostic apparatus 280 can receive the ECU configuration from the ECUs 1-4 of the vehicle system 100, when the communication between the vehicle diagnostic apparatus 280 and the vehicle system 100 is started.

The management center 250 includes a communication interface (I/F) 251, a random access memory (RAM) 252, a hard disk drive 253, and a CPU 254. The communication interface 251 mediates communication between the CPU 254 and the communication network 200. The CPU 254 executes various programs stored in the hard disk drive 253 and communicate with the ECUs 1-4 based on the executed program via the communication interface 251, the communication network 200, the base station 150, and the wireless communication unit 6. The CPU 254 transmits a signal including the diagnosis code request signal, the freeze data request signal, and the condition signal to the ECUs 1-4 during the communication.

The management center 250 can recognize the ECU configuration of the vehicle system 100 as follows. For example, the ECU configuration can be inputted to the management center 250 by the user before communication between the vehicle diagnostic apparatus 280 and the vehicle system 100. Alternatively, the management center 250 can receive the ECU configuration from the ECUs 1-4 of the vehicle system 100, when the communication between the management center 250 and the vehicle system 100 is started.

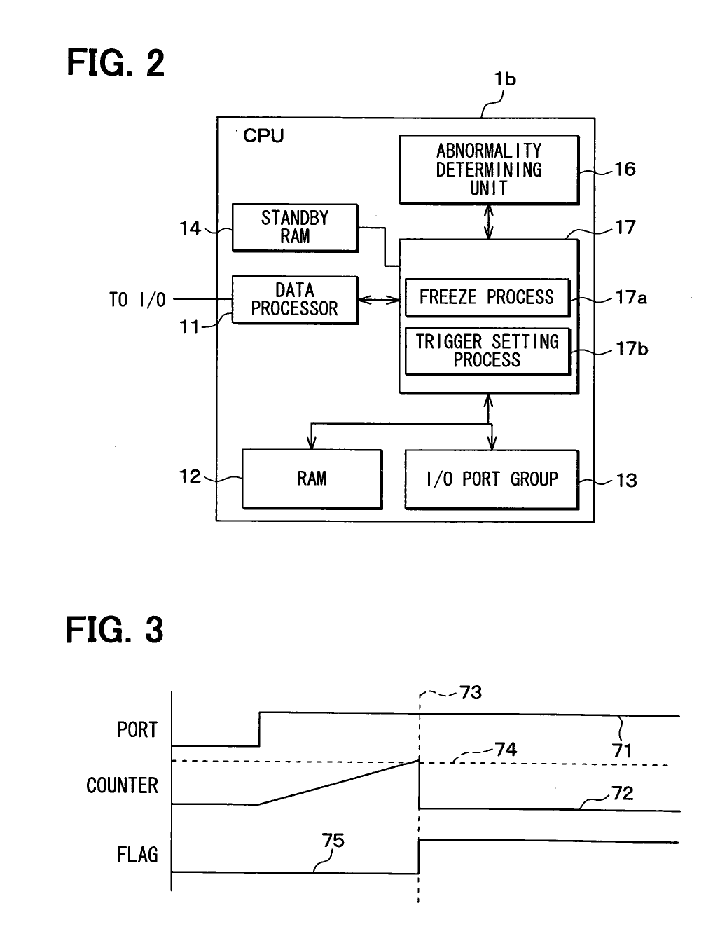

FIG. 2 schematically shows an internal structure of the CPU 1b of the ECU 1 of the vehicle system 100. The CPU 1c of the ECU 1 and the CPUs of the ECUs 2-4 can have the same structure as the CPU 1b shown in FIG. 2. As shown in FIG. 2, the CPU 1b includes a communication data processor 11, a RAM 12, an I/O port group 13, a standby RAM 14, an abnormality determining unit 16, and a control unit 17.

The communication data processor 11 is an interface circuit between the control unit 17 and the I/O unit 1a of the ECU 1.

The abnormality determining unit 16 and the control unit 17 execute processing using the RAM 12. For example, when the CPU 1b computes vehicle control data (e.g., engine fuel injection amount, target temperature in the vehicle, or the like), the vehicle control data is temporarily stored in the RAM 12. For another example, when the CPU 1b obtains vehicle behavior data (e.g., engine speed, carbon dioxide concentration in exhaust gas, steering angle, or the like) based on sensor signals from the sensors, the vehicle behavior data is temporarily stored in the RAM 12.

The I/O port group 13 has a plurality of I/O ports, each of which having a unique identification number. Signals are transmitted between the CPU 1b and the actuators and sensors through the I/O ports, respectively. The I/O port group 13 further includes a break detection port to detect a break in a line to the actuators.

The standby RAM 14 can hold information even after the power supply to the vehicle system 100 is interrupted.

The abnormality determining unit 16 determines whether the vehicle is in an abnormal condition in accordance with a predetermined abnormality determining criteria, which is preset in the manufacturing of the ECU 1. The result of the determination is outputted to the control unit 17. If the abnormality determining unit 16 determines that the vehicle is in an abnormal condition, the diagnosis code is outputted to the control unit 17 together with the determination result. There are no limitations on the predetermined abnormality determining criteria. For example, as shown in FIG. 3, by using an abnormality counter value 72 in the RAM 12 that increases regularly when a signal level 71 of the break detection port is continuously on (that is, the line is broken), and is reset to zero when the signal level 71 of the break detection port goes off, a state in which the abnormality counter value 72 exceeds a break detection port criterion value 74 may be used as an abnormality determining criterion. In this case, when the criterion is satisfied, the value 75 of the abnormality flag in the RAM 12 may be turned on to notify the control unit 17 of abnormality detection.

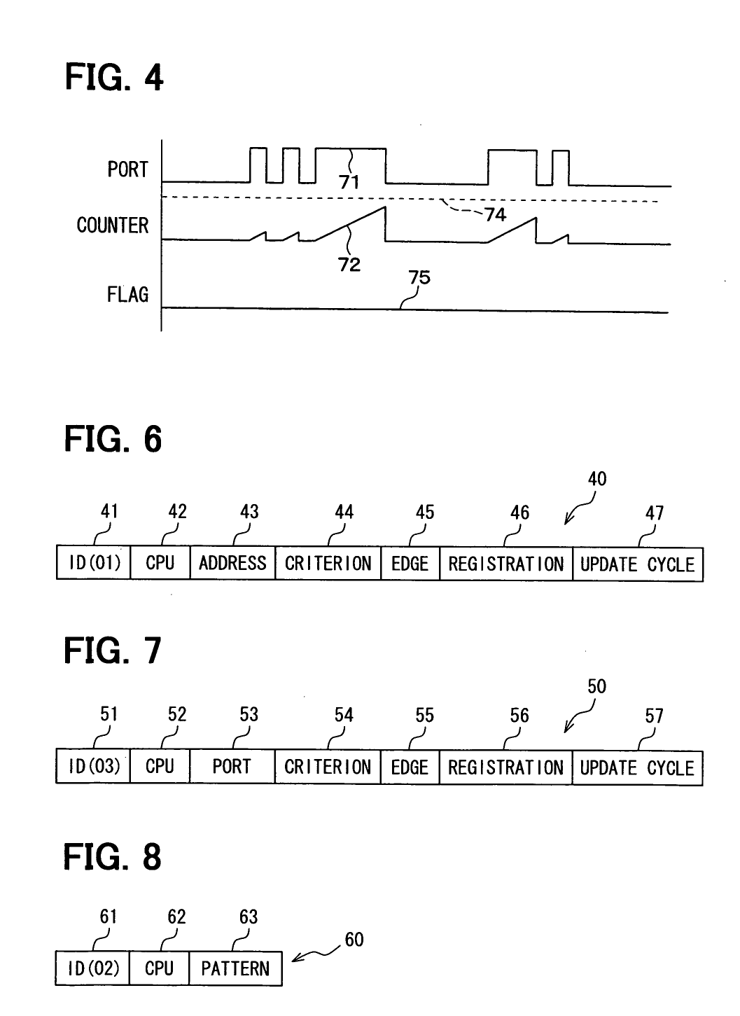

In the example of the abnormality determining unit 16, as shown in FIG. 3, when the break detection port is on over a predetermined time, abnormality is detected. However, as shown in FIG. 4, a situation may occur in which the break detection port does not hold ON state until the abnormality flag goes on. Although such a situation is not detected as abnormality at the manufacturing of the ECU 1, there is a case where it is determined after the manufacturing of the ECU 1 that such a situation has a relation with some failure of the vehicle. In a situation shown in FIG. 4, a concealed abnormality may exist within the break detection port.

The control unit 17 controls the actuators, obtains vehicle states based on signals from the sensors, and communicates with the ECUs 2-4 by using the communication data processor 11, the RAM 12, the I/O port group 13, the standby RAM 14, the EEPROM 1d, and the abnormality determining unit 16. Further, the control unit 17 executes a freeze process 17a and a trigger setting process 17b.

Firstly, the freeze process 17a is described below. Upon reception of the determination result indicating that the vehicle is in an abnormal condition from the abnormality determining unit 16, the control unit 17 copies the vehicle control data and/or the vehicle behavior data, which are stored in the RAM 12, to the standby RAM 14 as the freeze data together with the diagnosis code sent from the abnormality determining unit 16. Therefore, the freeze data includes the vehicle control data, the vehicle behavior data, and the diagnosis code. The freeze data is passed to a vehicle dealer, a vehicle maker, or the like, which analyzes the vehicle state in the abnormal condition using the freeze data.

Further, in the freeze process 17a, the control unit 17 repeatedly checks an external detection condition. When the check result is positive, the control unit 17 copies the vehicle control data and/or the vehicle behavior data, which are stored in the RAM 12, to the standby RAM 14 as the freeze data.

Furthermore, upon reception of the diagnosis code request signal from the management center 250 and the vehicle diagnostic apparatus 280, the control unit 17 transmits the diagnosis code to the source of the diagnosis code request signal. Upon reception of the freeze data request signal from the management center 250 and the vehicle diagnostic apparatus 280, the control unit 17 determines whether the freeze data is stored in the standby RAM 14. If the freeze data is stored in the standby RAM 14, the control unit 17 reads the freeze data from the standby RAM 14 and transmits the freeze data to the source of the freeze data request signal.

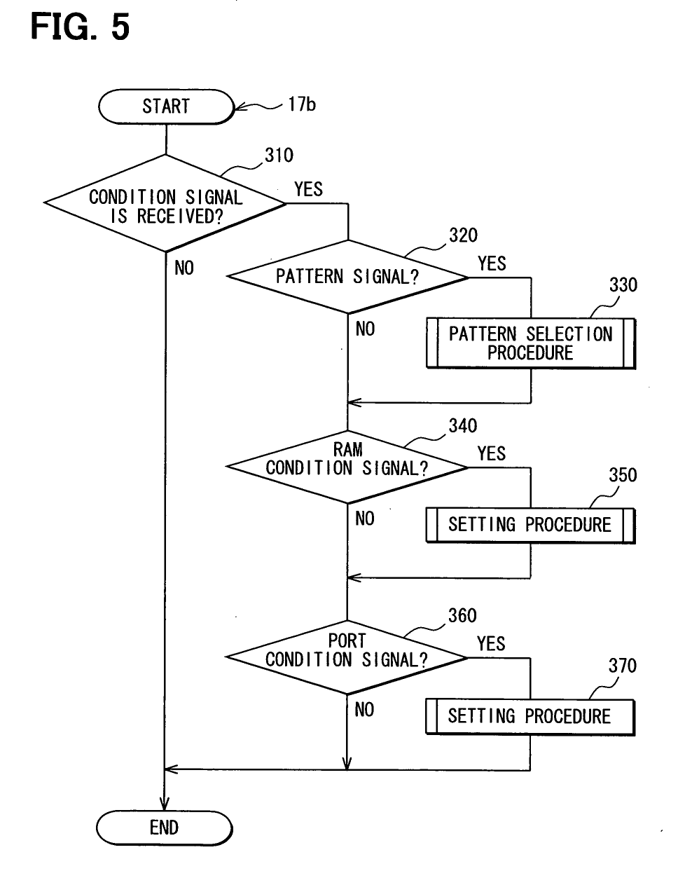

Next, the trigger setting process 17b is described below with reference to FIG. 5. The trigger setting process 17b starts at step 310, where the control unit 17 determines whether to receive the condition signal from outside the vehicle. If the control unit 17 receives the condition signal from outside the vehicle corresponding to YES as step 310, the trigger setting process 17b proceeds to step 320.

At step 320, the control unit 17 determines whether the condition signal is a pattern condition signal 60 shown in FIG. 8. If the condition signal is the pattern condition signal 60 corresponding to YES at step 320, the trigger setting process 17b proceeds to step 330, where the control unit 17 executes a pattern selection sequence, which is described later with reference to FIG. 12. If the condition signal is not the pattern condition signal corresponding to NO at step 320, the trigger setting process 17b proceeds to step 340.

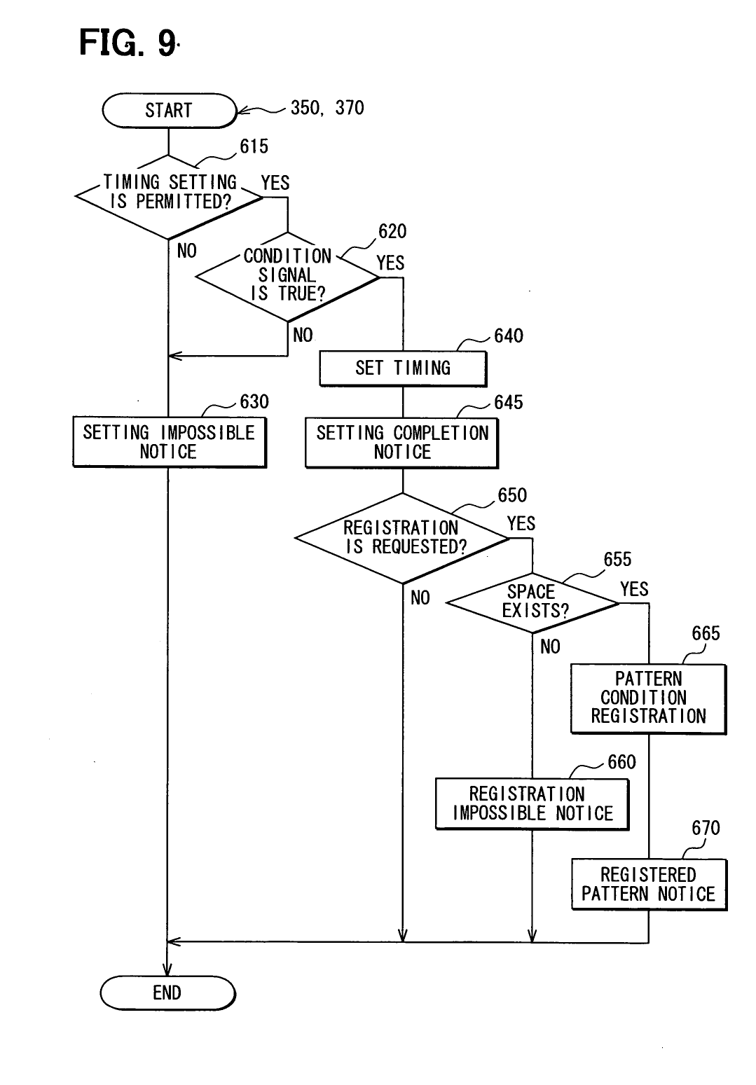

At step 340, the control unit 17 determines whether the condition signal is a RAM condition signal 40 shown in FIG. 6. If the condition signal is the RAM condition signal 40 corresponding to YES at step 340, the trigger setting process 17b proceeds to step 350, where the control unit 17 executes an external setting sequence, which is described later with reference to FIG. 9. If the condition signal is not the RAM condition signal 40 corresponding to NO at step 340, the trigger setting process 17b proceeds to step 360.

At step 360, the control unit 17 determines whether the condition signal is a port condition signal 50 shown in FIG. 7. If the condition signal is the port condition signal 50 corresponding to YES at step 360, the trigger setting process 17b proceeds to step 370, where the control unit 17 executes the external setting sequence. If the condition signal is not the port condition signal 50 corresponding to NO at step 360, the trigger setting process 17b proceeds to step 370.

Here, the condition signal is described in detail. As described previously, the condition signal is transmitted from the management center 250 and the vehicle diagnostic apparatus 280 to the ECU 1. The condition signal includes the RAM condition signal 40, the port condition signal 50, and the pattern condition signal 60.

As shown in FIGS. 6-8, the condition signals 40, 50, and 60 respectively has ID fields 41, 51, and 61 as a header field. For example, the length of each of the ID fields 41, 51, and 61 is one byte, and values “01”, “03”, and “02” are set to the ID fields 41, 51, and 61, respectively. In accordance with the ID fields 41, 51, and 61, the control unit 17 determines whether the condition signal is the RAM condition signal 40, the port condition signal 50, or the pattern condition signal 60.

The condition signals 40, 50, and 60 has CPU number fields 42, 52, and 62 following the ID fields 41, 51, and 61. For example, the length of each of the CPU number fields 42, 52, and 62 is one byte. The CPU number fields 42, 52, and 62 store numbers of destination CPUs (e.g., CPU 1b, CPU 1c), to which the condition signals 40, 50, and 60 are transmitted. When receiving the condition signals 40, 50, and 60, the CPUs of the ECUs 1-4 determine whether the received condition signals 40, 50, and 60 are directed to themselves based on the CPU number fields 42, 52, and 62.

The management center 250 and the vehicle diagnostic apparatus 280 can recognize CPU number configuration of the vehicle system 100 as follows. The CPU number configuration indicates which CPU of the ECUs 1-4 has which number. For example, the CPU number configuration can be inputted to the management center 250 and the vehicle diagnostic apparatus 280 by the user before communication between the management center 250 and the vehicle diagnostic apparatus 280, and the vehicle system 100. Alternatively, the management center 250 and the vehicle diagnostic apparatus 280 can receive the CPU number configuration from the ECUs 1-4, when the communication between the management center 250 and the vehicle diagnostic apparatus 280, and the vehicle system 100 is started.

The RAM condition signal 40 has an address field 43 (e.g. 4 byte length) following the CPU number field 42, a criteria field 44 (e.g. 4 byte length) following the address field 43, an edge field 45 (e.g. 1 byte length) following the criteria field 44, a registration field 46 (e.g. 1 byte length) following the edge field 45 and an update cycle field 47 (e.g. 4 byte length) following the registration field 46.

The port condition signal 50 has an port number field 53 (e.g. 4 byte length) following the CPU number field 52, a criteria field 54 (e.g. 4 byte length) following the port number field 53, an edge field 55 (e.g. 1 byte length) following the criteria field 54, a registration field 56 (e.g. 1 byte length) following the edge field 55, and an update cycle field 57 (e.g. 4 byte length) following the registration field 56.

The pattern condition signal 60 has a pattern number field 63 (e.g., 4 byte length) following the CPU number field 62.

The external setting sequence executed at steps 350, 370 of FIG. 5 is described below with reference to FIG. 9. The external setting sequence starts at step 615, where the control unit 17 determines whether the vehicle is in a trigger timing setting permission state. For example, the control unit 17 can determine that the vehicle is in the trigger timing setting permission state when the vehicle is stopped (i.e., the vehicle engine is not activated), and the control unit 17 can determine that the vehicle is not in the trigger timing setting permission state when the vehicle is running. For another example, the control unit 17 can determine that the vehicle is in the trigger timing setting permission state when no data is written to the EEPROM 1d, and the control unit 17 can determine that the vehicle is not in the trigger timing setting permission state when data is written to the EEPROM 1d. If the vehicle is in the trigger timing setting permission state corresponding to YES at step 615, the external setting sequence proceeds to step 620. If the vehicle is not in the trigger timing setting permission state corresponding to NO at step 615, the external setting sequence proceeds to step 630.

At step 620, the control unit 17 determines whether the received condition signal meets a predetermined format requirement. For example, the control unit 17 determines that the condition signal meets the format requirement when the length of the received condition signal is equal to a predetermined length. If the condition signal meets the format requirement corresponding to YES at step 620, the external setting sequence proceeds to step 640. If the condition signal does not meet the format requirement corresponding to NO at step 620, the external setting sequence proceeds to step 630.

At step 630, the control unit 17 transmits a signal indicating that the vehicle is not in the trigger timing setting permission state to the source (i.e., the management center 250 or the vehicle diagnostic apparatus 280) of the condition signal. Then, the external setting sequence is completed.

At step 640, the control unit 17 sets a trigger timing. Specifically, the control unit 17 extracts a trigger part (corresponding to an example of a first condition) of the RAM condition signal 40 or the port condition signal 50. The extracted trigger part is stored in a trigger timing setting area of the EEPROM 1d. The previously described freeze process 17a checks the external detection condition based on the trigger part stored in the EEPROM 1d.

The trigger part can overwrite old trigger part stored in the trigger timing setting area. Alternatively, the trigger part can be added to the old trigger part. The trigger part of the RAM condition signal 40 consists of the address field 43, the criteria field 44, the edge field 45, the registration field 46, and the update cycle field 47. The trigger part of the port condition signal 50 consists of the port number field 53, the criteria field 54, the edge field 55, the registration field 56, and the update cycle field 57. Therefore, the external detection condition checked by the freeze process 17a can be set by the management center 250 and the vehicle diagnostic apparatus 280.

After step S640, the external setting sequence proceeds to step 645, where the control unit 17 transmits a signal indicating that the trigger timing setting is completed to the source (i.e., the management center 250 or the vehicle diagnostic apparatus 280) of the condition signal.

After step S645, the external setting sequence proceeds to step 650, where the control unit 17 determines whether a pattern condition registration request is present based on a value of the registration field of the received condition signal. For example, the control unit 17 can determine that the pattern condition registration request is present when the value of the registration field is “0x01”, and the control unit 17 can determine that the pattern condition registration request is not present when the value of the registration field is “0x00”. Therefore, the pattern condition registration request can be set by the management center 250 and the vehicle diagnostic apparatus 280. If the pattern condition registration request is present corresponding to YES at step 650, the external setting sequence proceeds to step 655. If the pattern condition registration request is not present corresponding to NO at step 650, the external setting sequence is ended.

At step 655, the control unit 17 determines whether a storage area has free space large enough to store the pattern condition. If the storage has free space corresponding to YES at step 655, the external setting sequence proceeds to step 665. If the storage area has no free space corresponding to NO at step 655, the external setting sequence proceeds to step 660. The storage area can be located in the RAM 12, the EEPROM 1d, or the standby RAM 14.

At step 660, the control unit 17 transmits a signal indicating that the pattern condition cannot be registered to the source (i.e., the management center 250 or the vehicle diagnostic apparatus 280) of the condition signal. After step 660, the external setting sequence is ended.

At step 665, the control unit 17 adds the pattern condition to the storage area. The pattern condition consists of the trigger part of the received condition signal and a pattern number field. The length of the pattern number field is set less than the total length of the trigger part. For example, the length of the pattern number field is 4 byte. The pattern number field stores a unique pattern number.

After step 665, the external setting sequence proceeds to step 670, where the control unit 17 transmits a pattern notice signal indicating the pattern number of the currently registered pattern condition to the source (i.e., the management center 250 or the vehicle diagnostic apparatus 280) of the condition signal. After step 670, the external setting sequence is ended.

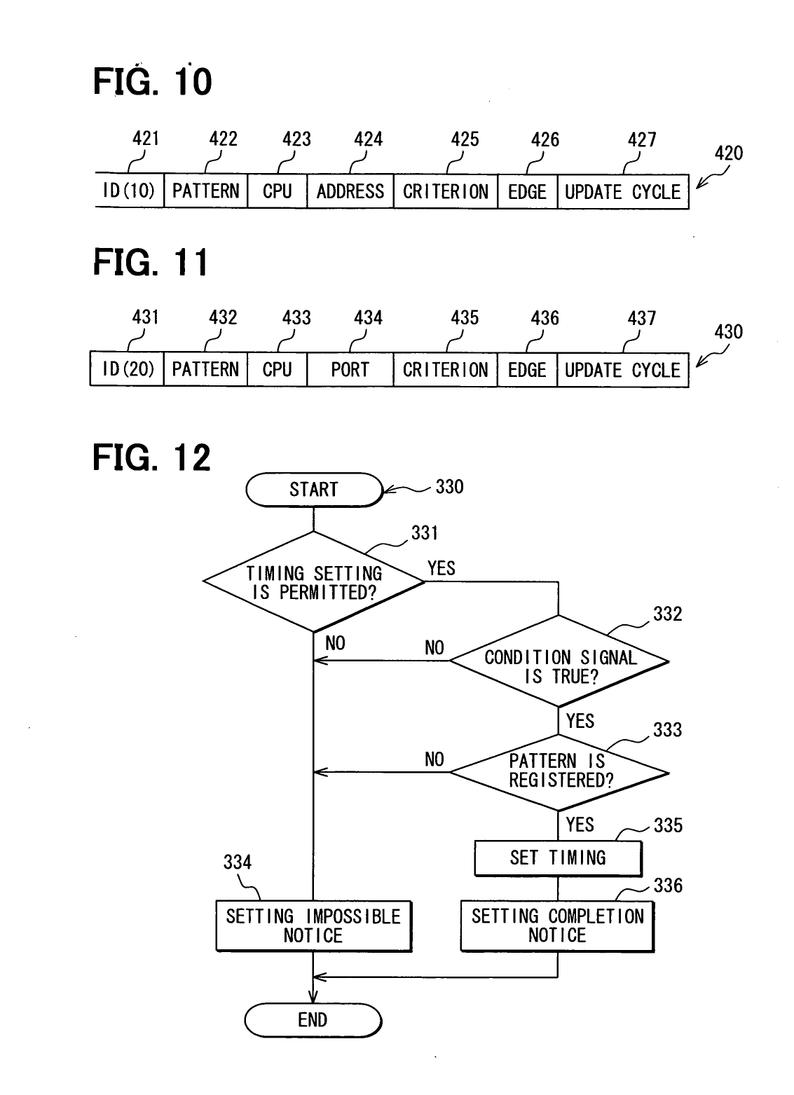

Two examples of a data structure of the pattern notice signal are shown in FIGS. 10, 11.

When the pattern condition is registered according to the RAM condition signal 40 shown in FIG. 6, the control unit 17 transmits a RAM pattern notice signal 420 shown in FIG. 10 to the source of the condition signal. The RAM pattern notice signal 420 has an ID field 421, a pattern number field 422 following the ID field 421, a CPU number field 423 following the pattern number field 422, an address field 424 following the CPU number field 423, a criteria field 425 following the address field 424, an edge field 426 following the criteria field 425, and an update cycle field 427 following the edge field 426. The ID field 421, the CPU number field 423, the address field 424, the criteria field 425, the edge field 426, and the update cycle field 427 of the RAM pattern notice signal 420 have the same value as the ID field 41, the CPU number field 42, the address field 43, the criteria field 44, the edge field 45, and the update cycle field 47 of the RAM condition signal 40, respectively. The pattern number of the currently registered pattern condition is stored in the pattern number field 422.

When the pattern condition is registered according to the port condition signal 50 shown in FIG. 7, the control unit 17 transmits a port pattern notice signal 430 shown in FIG. 11 to the source of the condition signal. The port pattern notice signal 430 has an ID field 431, a pattern number field 432 following the ID field 431, a CPU number field 433 following the pattern number field 432, an port number field 434 following the CPU number field 433, a criteria field 435 following the port number field 434, an edge field 436 following the criteria field 435, and an update cycle field 437 following the edge field 436. The ID field 431, the CPU number field 433, the port number field 434, the criteria field 435, the edge field 436, and the update cycle field 437 of the port pattern notice signal 430 have the same value as the ID field 51, the CPU number field 52, the port number field 53, the criteria field 54, the edge field 55, and the update cycle field 57 of the port condition signal 50, respectively. The pattern number of the currently registered pattern condition is stored in the pattern number field 432.

Alternatively, at step 670 of the external setting sequence, the control unit 17 can transmit a just previously registered pattern number instead of the currently registered pattern number to the source of the condition signal.

Thus, when receiving the RAM condition signal 40 or the port condition signal 50, the control unit 17 executes the external setting sequence. In such an approach, the control unit 17 can set the trigger timing (refer to step 615). If the condition signal meets the format requirement (refer to step 620), the control unit 17 sets the trigger timing in accordance with the condition signal (refer to step 640). The control unit 17 transmits the signal indicating that the trigger timing setting is completed to the source of the condition signal (refer to step 645).

When the vehicle is not in the trigger timing setting permission state (refer to step 620) or when the condition signal does not meet the format requirement (refer to step 620), the control unit 17 transmits the signal indicating that the trigger timing setting is impossible to the source of the condition signal (refer to step 630).

After setting the trigger timing, when the pattern condition registration request is present in the condition signal (refer to step 650), and when the storage area has the free space large enough to store the pattern condition (refer to step 655), the control unit 17 adds the pattern condition to the storage area (refer to step 665). The pattern condition consists of the trigger part of the received condition signal and the pattern number. The control unit 17 transmits the pattern notice signal indicating the pattern number of the currently registered pattern condition to the source of the condition signal (refer to step 670).

Further, after setting the trigger timing, when the pattern condition registration request is present in the condition signal (refer to step 650), and when the storage area has no free space large enough to store the pattern condition (refer to step 655), the control unit 17 transmits the signal indicating that the pattern condition cannot be registered to the source of the condition signal (refer to step 660).

The management center 250 and the vehicle diagnostic apparatus 280 may transmit a cancel signal to cancel specific ones or all of set trigger timings, based on user's operations and the like, to the CPUs in the vehicle system 100. Each CPU in the vehicle system 100, when receiving the cancel signal, may clear the setting of trigger timing specified in the cancel signal.

Moreover, the management center 250 and the vehicle diagnostic apparatus 280 may transmit a delete signal to delete specific ones or all of stored pattern conditions, based on user's operations and the like, to the CPUs in the vehicle system 100. Each CPU in the vehicle system 100, when receiving the delete signal, may delete a pattern condition specified in the delete signal from the storage area.

The following describes the pattern selection sequence executed at step 330 of the trigger setting process 17b. FIG. 12 is a flowchart showing details of the pattern selection sequence. After receiving the pattern condition signal 60 shown in FIG. 8, the control unit 17, at step 331 of the pattern selection sequence, determines whether the vehicle is in trigger timing setting permission state, in the same way as step 615 of the external setting sequence. If the vehicle is in the trigger timing setting permission state corresponding to YES at step 331, the pattern selection sequence proceeds to step 332. If the vehicle is not in the trigger timing setting permission state corresponding to NO at step 331, the pattern selection sequence proceeds to step 334.

At step 332, the control unit 17 determines whether the received pattern condition signal 60 meets the format requirement in the same way as step 620 of the external setting sequence. If the received pattern condition signal 60 meets the format requirement corresponding to YES at step 332, the pattern selection sequence proceeds to step 333. If the received pattern condition signal 60 does not meet the format requirement corresponding to NO at step 332, the pattern selection sequence proceeds to step 334.

At step 333, the control unit 17 determines whether a pattern number stored in the pattern number field 63 (refer to FIG. 8) of the received condition signal 60 is already registered in the storage area. If the pattern number is already registered in the storage area corresponding to YES at step 333, the pattern selection sequence proceeds to step 335. If the pattern number is not registered in the storage area corresponding to NO at step 333, the pattern selection sequence proceeds to step 334.

At step 334, like step 630 of the external setting sequence, the control unit 17 transmits the signal indicating that the trigger timing setting is impossible to the source of the condition signal, and then the pattern selection sequence is ended.

At step 335, the control unit 17 performs the trigger timing setting. Specifically, the control unit 17 reads the trigger part of the pattern condition from the storage area and determines whether the read trigger part is already stored in the trigger timing setting area of the EEPROM 1d. If stored, the external setting sequence proceeds to step 336, and otherwise newly overwrites the trigger timing setting area with the trigger part or adds it, and then proceeds to step 336.

At step 336, like step 645 of the external setting sequence, the control unit 17 transmits the signal indicating that the trigger timing setting is completed to the source of the condition signal, and then the pattern selection sequence is ended.

Thus, when receiving the pattern condition signal 60, the control unit 17, by executing the pattern selection sequence, when it can set trigger timing for itself (refer to step 331), when the condition signal meets the formal requirement (refer to step 332), and when the pattern number in the condition signal is already registered (refer to step 333), sets a trigger part registered as a pattern condition together with the pattern number as trigger timing (if not set at that time) (refer to step 336), and further transmits a notice of the trigger timing setting completion to the source of the condition signal (refer to step 336).

The control unit 17, when it cannot set the trigger timing for itself (refer to step 331), when the condition signal does not meet the format requirement (refer to step 332), or when the pattern number in the condition signal is not registered (refer to step 333), transmits the notice that the trigger timing setting is impossible, to the source of the condition signal (refer to step 334).

The following describes repeated determination of the external detection condition of the freeze process 17a. The control unit 17 reads at least one of trigger parts from the trigger timing setting area during the freeze process 17a, for each of the read trigger parts, determines an external detection condition (corresponding to one example of detection conditions of claims), based on the content of the each trigger part. Furthermore, the control unit 17 determines a determination cycle of the external detection condition, based on the content of the each trigger part, and makes determination according to the determined external detection condition and determination cycle.

When at least one of the external detection conditions is determined to be positive, the control unit 17 copies the vehicle control data and/or the vehicle behavior data in the RAM 12 to the standby RAM 14 as freeze data.

More specifically, an external detection condition on a certain trigger part is determined based on the address field 43, the criteria field 44, and the edge field 45. For example, an external detection condition is defined as “an address of the RAM 12 described in the address field 43 is greater than a reference value described in the criteria field 44” if the value of the edge field 45 is a rising value (e.g., 0x01). For another example, an external detection condition is defined as “an address of the RAM 12 described in the address field 43 is less than a reference value described in the criteria field 44” if the value of the edge field 45 is a falling value (e.g., 0x11). The address of the RAM 12 may be, for example, an address to store acquired engine coolant temperature, or the value of the abnormality counter of the above-described break detection port.

An external detection condition on a certain trigger part is determined based on the port number field 53, the criteria field 54, and the edge field 55 when the trigger part is the trigger part of the port condition signal 50. For example, an external detection condition is defined as “a signal level in a port number described in the port number field 53 is greater than a reference value described in the criteria field 54” if the value of the edge field 55 is a rising value. For another example, an external detection condition is defined as “a signal level in a port number described in the port number field 53 is less than a reference value described in the criteria field 55” if the value of the edge field 55 is an falling value (e.g., 0x11).

A determination cycle on a certain trigger part is set to a value described in the update cycle field 47 or update cycle field 57.

More specifically, freeze data, which is stored when an external detection condition is satisfied, is the vehicle control data or the vehicle behavior data in several timings of determining the external condition before and after the timing in which the external condition is satisfied. This is achieved, for example, by storing the vehicle control data or the vehicle behavior data behavior for each determination timing by using the RAM 12 as an FIFO buffer.

In the ECU 1 that operates as described above, for example, consider the case where the RAM condition signal 40 is transmitted from the management center 250 or the vehicle diagnostic apparatus 280 to the CPU 1b of the ECU 1. At this time, assume that the address field 43 of the RAM condition signal 40 has the address in which the abnormality counter in the above-described example of the break detection port is stored, the criteria field 44 has a value smaller than the break detection port reference value 74 (refer to FIGS. 3, 4) in the abnormality determining unit 16, and the edge field 45 has a rising value.

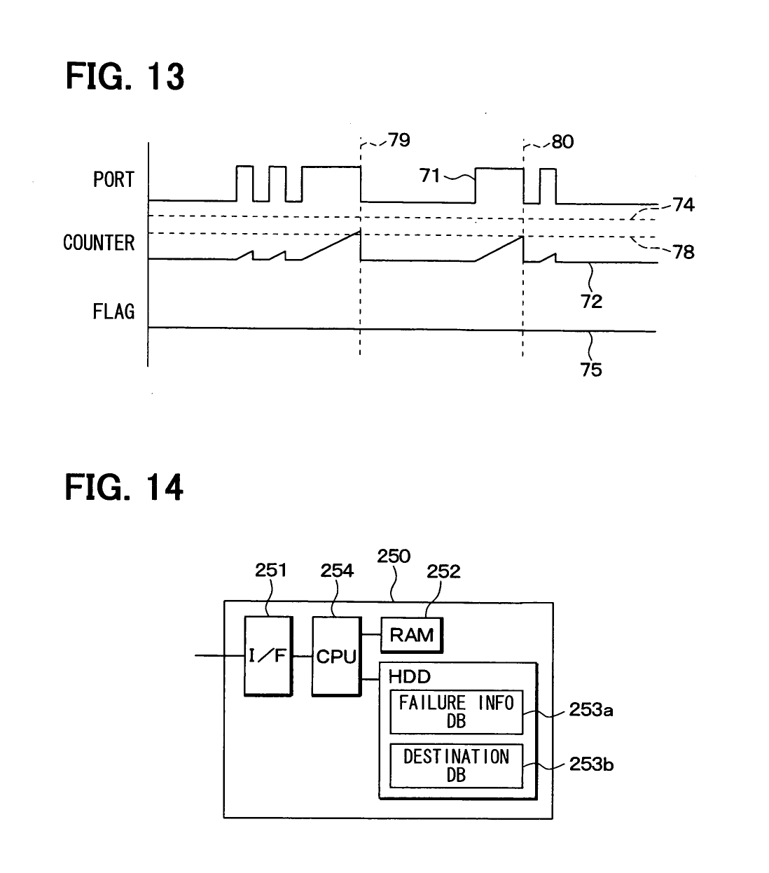

In this case, as shown in FIG. 13, even when the value of the abnormality counter does not reach a break detection port reference value 74 in the abnormality determining unit 16, that is, when it appears to the abnormality determining unit 16 that abnormality exists within the port (or RAM), by properly setting the reference value 78 of the criteria field 44, for example, at the timing 79 or the timing 80, the freeze process 17a can detect abnormality and store freeze data.

As described above, each CPU of the ECUs 1-4 has a function to determine whether an external detection condition based on a condition signal received from the management center 250 and the vehicle diagnostic apparatus 280 outside the vehicle is satisfied, and further has a function to store freeze data when the determination proves to be positive. Thereby, the timing of storing freeze data (that is, the sensitivity of freeze data collection) can be complicatedly set from outside the vehicle.

The external detection condition defines the relationship between values stored in specific addresses of the RAM 12 and predetermined reference values. This allows various conditions for data values in the RAM 12 to be set as external detection conditions from outside the vehicle. In this embodiment, the timing of determining whether to store freeze data can be changed without changing the operation content of the abnormality determining unit 16.

The external detection condition defines the relationship between signal levels in ports of the input-output port group 13 and predetermined reference values. This allows various conditions for a signal level in a relevant port to be set as external detection conditions from outside the vehicle.

The ECU 1 stores a set external detection condition together with a pattern number having a shorter data length than data (that is, trigger part) indicating the external detection condition. Therefore, when receiving a certain pattern number (corresponding to an example of second identification code) from the management center 250 or the vehicle diagnostic apparatus 280, the ECU 1 may set the trigger part stored together with the pattern number as an external detection condition of vehicle abnormality, based on the fact that the stored pattern number and the received pattern number match, and the trigger part stored together with the pattern number is excluded from a trimming setting area.

By this construction, even an external detection condition set previously that was excluded from setting targets can be enabled again by outputting a pattern number stored together with the external detection condition. In short, even when the previously set external detection condition is disabled, the disabled external detection condition can be enabled again by outputting a pattern number stored together with the external detection condition. By using such a pattern number, when a certain external detection condition is set again, efforts to newly transmit a trigger part having a longer data length than the pattern number from the outside can be saved.

The ECU 1 stores a set detection condition in the EEPROM 1d that can hold information even when power supply to the ECU 1 from outside the ECU 1 is stopped. By this construction, even after a vehicle battery used as a power source of the ECU 1 is removed to repair failure of the ECU 1, external detection conditions stored in the EEPROM 1d can continue to be used. Therefore, it becomes easy to make sure that the ECU 1 functions normally after the repair.

When the ECU 1 receives a condition signal from outside the vehicle, it prohibits a trigger part of the condition signal from being set in a trigger timing setting area as a condition of detecting vehicle abnormality, based on the fact that various impediment conditions (second conditions) are satisfied. This reduces the possibility of setting received trigger parts even in the case where it is inconvenient to set external detection conditions, as external detection conditions.

When the ECU 1 has performed such prohibition processing, the ECU 1 transmits a signal indicating that a received trigger part cannot be set as a detection condition of vehicle abnormality, to the management center 250 or the vehicle diagnostic apparatus 280 that has transmitted the condition signal. Thus, by indicating the fact that it has been impossible to set an external detection condition from a device outside the vehicle, to the external device, the operator of the external device can be promoted to rethink the validity of setting the external detection condition.

When the ECU 1 receives a condition signal from a device outside the vehicle, the ECU 1 sets a cycle contained in the condition signal as a determination cycle (corresponding to an example of update cycle) of the freeze process 17a. By doing so, the determination cycle of the freeze process 17a corresponding to the property of abnormality to be checked can be set from outside the vehicle.

### Second Embodiment

A second embodiment of the present invention is described below. This embodiment assumes that the vehicle system 100 as described in the first embodiment is mounted in plural vehicles. The management center 250 communicates with ECUs in the plural vehicle systems 100, selects the same types of vehicle systems from among the plural vehicle systems 100, and transmits same condition signals to ECUs of the same types of vehicle systems 100.

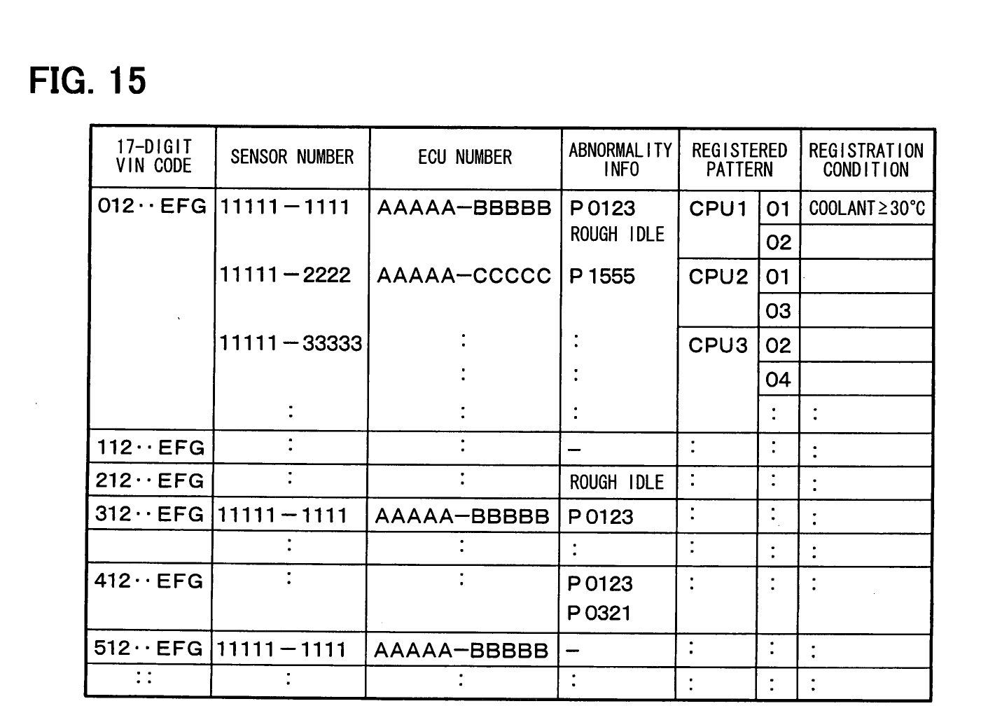

FIG. 14 schematically shows the construction of the management center 250 of this embodiment. The hard disk drive 253 of the management center 250 of this embodiment stores a failure information DB 253a and a vehicle destination DB 253b to achieve the above-described operation. FIG. 15 shows the data structure of the failure information DB 253a. The failure information DB 253a contains plural records corresponding to vehicles (that is, the vehicle system 100) different from each other. Each record includes a VIN code field, a mounted sensor product number field, a mounted ECU field, an abnormality information field, a registered pattern number field, and a registration condition field.

The VIN code field contains a VIN code that is a number for uniquely identifying a relevant vehicle. From the VIN code, the model, type, and the like of a vehicle having the VIN code can be determined. The mounted sensor product number field contains the product numbers of plural sensors mounted in a relevant vehicle. The abnormality information field contains diagnosis code of abnormality previously detected by the abnormality determining unit 16 in each CPU in the vehicle system 100 of a relevant vehicle, or information indicating rough idle. The rough idle refers to a state, in which although a CPU does not detect abnormality, the driver and an inspector feel that the behavior of the vehicle is abnormal. Information indicating rough idle is stored by input to the vehicle system 100 or input to a computer of a vehicle dealer by personnel of the vehicle dealer or a driver who recognizes rough idle.

The registered pattern number field contains one or more pairs of one CPU of the vehicle system 100 in a relevant vehicle and one or more pattern numbers in pattern conditions registered in the CPU. The registration condition field contains a trigger part corresponding to each pattern number of the register pattern number field.

The vehicle destination DB (database) 253b contains the correspondences between vehicle VIN codes and destinations for wireless communication with individual ECUs in the vehicle system 100 mounted in the vehicle.

The management center 250 may acquire information of each record of the failure information DB 253a and information on the vehicle destination DB 253b by input operations of operators of the management center 250, through communication with each vehicle system 100, or over the communication network 200 from a computer installed in each vehicle dealer.

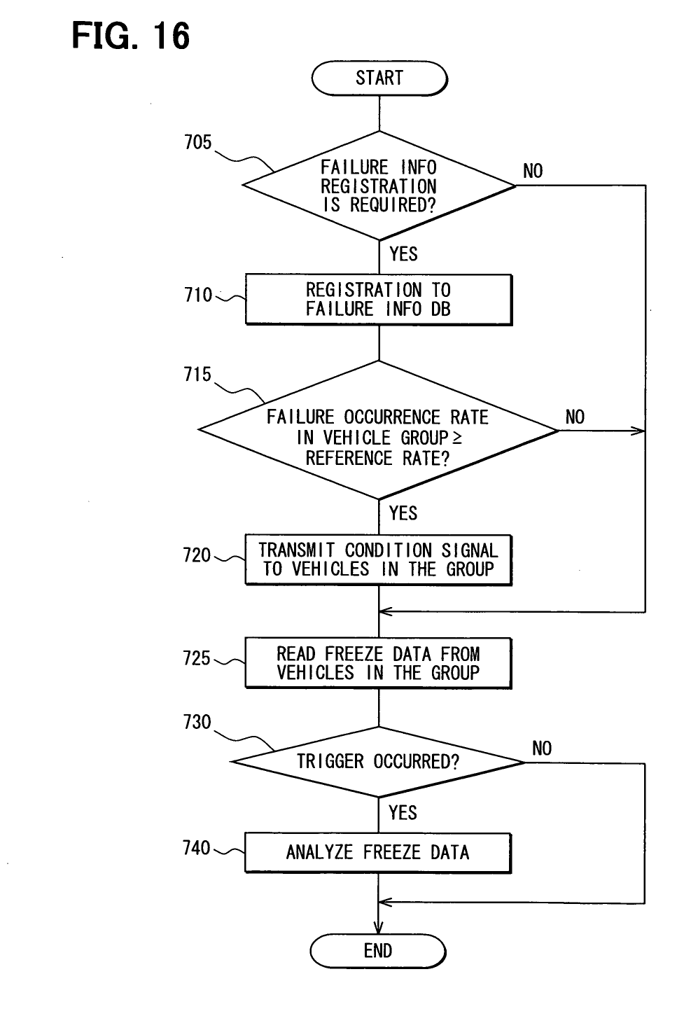

The following describes a sequence for acquisition of the failure information DB 253a and repeated execution of the CPU 254 to broadcast condition signals by use of the failure information DB 253a and the vehicle destination DB 253b. A flowchart of the sequence is shown in FIG. 16. Hereinafter, information corresponding to each record of the failure information DB 253a is referred to as vehicle failure information.

The sequence starts at step 705, where the CPU 254 determines whether to acquire vehicle failure information to register the vehicle failure information in the failure information DB 253a. The timings of the registration include the case where the vehicle failure information is received from a dealer over the communication network 200, the case where operators of the management center 250 input the vehicle failure information, and the case where predetermined timing of an inquiry about the vehicle failure information to each vehicle system arrives. If the vehicle failure information is not registered corresponding to NO at step 705, the sequence proceeds to step 725. If the vehicle failure information is registered corresponding to YES at step 705, the sequence proceeds to step 710.

At step 710, the CPU 254 acquires the vehicle failure information and registers the vehicle failure information in the failure information DB 253a. At the timing inquiring the vehicle failure information from the vehicle system 100, the CPU 254 determines the destination of a vehicle about which to make an inquiry, based on the vehicle destination DB 253b, and outputs a signal to request failure information to the ECU of the destination.

When a CPU in an ECU to which the vehicle system 100 of this embodiment belongs receives a signal to request the vehicle failure information via the wireless communication unit 6 and the like, the CPU transmits the vehicle failure information to the requester. Therefore, the CPU 254 of the management center 250 can record the vehicle failure information from individual CPUs that responded to the requesting signals in the failure information DB 253a collectively for each of the vehicle systems 100.

At step 715, based on the content of the failure information DB 253a, one or more of a group belonging to the same type are determined. Specifically, based on models that can be determined by the data of the VIN code field, sensor types that can be determined by the data of the mounted sensor product number field, and ECU types that can be determined by the data of the mounted ECU product number field, a similar vehicle group (e.g., a group of vehicles that have the same model with 80 percent or more, or 100 percent of the total number of sensors and ECUs having the same type) is determined.

At step 715, the CPU 254, for each group, determines whether there is a failure type (specific diagnosis code, rough idle, etc.) occurring in a larger number of vehicles than a reference occurrence rate in the same group, based on the data of the abnormality information field of the failure information DB 253a. If the determination result is positive corresponding to YES at step 715, the sequence proceeds to step 720. If the determination result is negative corresponding to NO at step 715, the sequence proceeds to step 725.

At step 720, the CPU 254 transmits at a time same condition signals to each ECU in all vehicle systems 100 belonging to the vehicle group that the determination result becomes positive at step 715. Whether to transmit condition signals having what contents may be decided based on the data of the correspondence between failure types recorded in advance and trigger parts, or operation by selection judgment of an operator. Thus, by transmitting the same condition signals to plural vehicles, the timing of preparing freeze data of vehicles in which a same type of failure may occur can be set at a time.

At step 725, a signal to request freeze data is transmitted to ECUs to which a condition signal has been transmitted so far. When CPUs in ECU belonging to the vehicle system 100 of this embodiment receive a signal to request freeze data via the wireless communication unit 6 and the like, if freeze data exists currently in the standby RAM 14, they transmit it to a requester. Therefore, the CPU 254 of the management center 250 can acquire freeze data from each CPU that responded to the signal to request failure information.

At step 730, the CPU 254 determines whether a trigger corresponding to the transmitted condition signal occurred, that is, an external detection condition corresponding to the condition signal was satisfied to receive freeze data from a CPU in the vehicle system 100. If the freeze data is received corresponding to YES at step 730, the CPU 254 executes processing for having the operator analyze the content of the acquired freeze data (e.g., display processing). Thus, based on the fact that there are a larger number of abnormality states than a reference rate for a vehicle group belonging to a same type, the management center 250 transmits condition signals to ECUs of vehicles belonging to the group, whereby settings of external detection conditions for plural vehicles can be collectively managed.

Each of pieces of information for grouping plural vehicles is data containing numbers for individually identifying the vehicles, the identification numbers of ECUs mounted in the vehicles, and the identification numbers of sensors connected to the ECUs. By using vehicle model identification information thus structured, a vehicle type belonging to a same type can be more properly determined.

Each CPU of each ECU in the vehicle system 100, in addition to the functions of the first embodiment, on receiving a signal to request vehicle failure information containing a recorded pattern condition from the management center 250 outside the vehicle via the wireless communication unit 6, transmits the pattern condition and the like to the management center 250 via the wireless communication unit 6. By this construction, the management center 250 can request a pair of an external detection condition and a pattern number recorded within a CPU from the CPU to acquire it.

### Third Embodiment

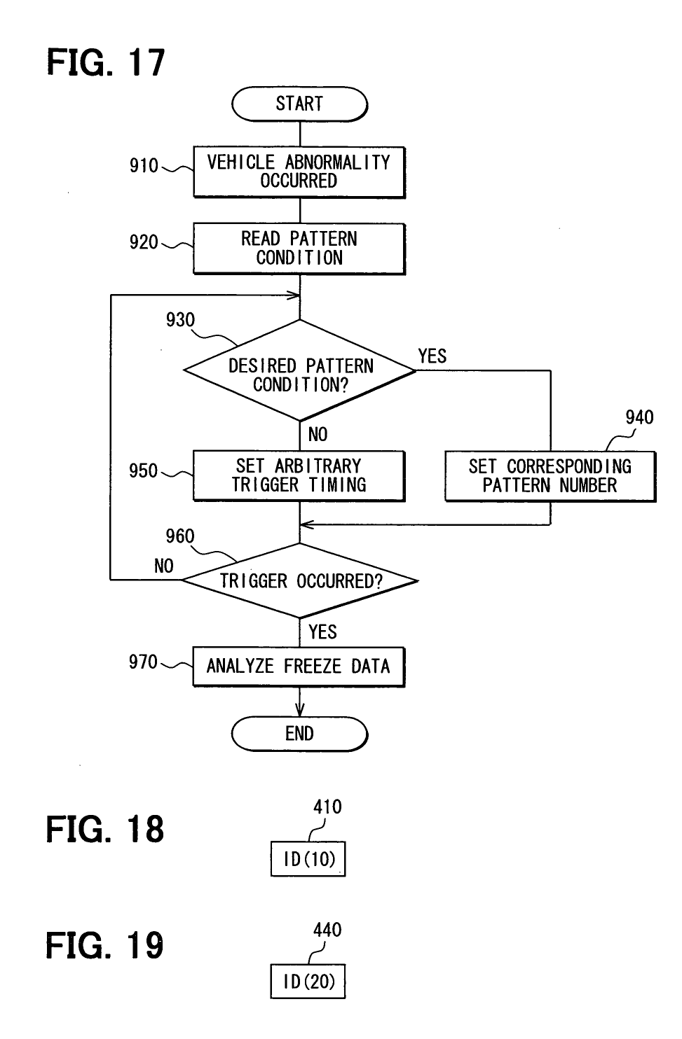

The following describes a third embodiment of the present invention. This embodiment shows an example of a procedure by which an operator of a vehicle dealer or the like analyzes vehicle failure by using the management center 250 described in the second embodiment or the vehicle diagnostic apparatus 280 described in the first embodiment. FIG. 17 is a flowchart showing the procedure.

The operator recognizes the occurrence of abnormality of the vehicle (step 910). The recognition may be realized as shown in the second embodiment in which the management center 250 is used to acquire vehicle failure information from each CPU of the vehicle system 100 of the vehicle, by acquiring diagnosis code from each CPU of the vehicle system 100 by using the vehicle diagnostic apparatus 280, or receiving a report of a sense of incongruity of the vehicle from the vehicle user.

On recognizing vehicle abnormality, the operator reads pattern information of each CPU in the vehicle system 100 (step 920). This processing may be realized by reading records on a relevant vehicle in the failure information DB 253a. Or this processing may be realized by acquiring information of a pattern condition from each CPU by operating the vehicle diagnostic apparatus 280 to transmit a signal to request the pattern condition to each CPU.

Each CPU of each ECU in the vehicle system 100, in addition to the functions of the first and the second embodiments, on receiving the signal to request a pattern condition from the vehicle diagnostic apparatus 280 via the bidirectional communication unit 5, transmits the pattern condition to the vehicle diagnostic apparatus 280 via the bidirectional communication unit 5. By this construction, the vehicle diagnostic apparatus 280 can request a pair of an external detection condition and a pattern number recorded in a CPU from the CPU to acquire it.

Examples of a signal to request a pattern condition are shown in FIGS. 18 and 19. A RAM pattern request signal 410 shown in FIG. 18 is a signal to selectively request a pattern condition corresponding to a condition on RAM from among pattern conditions. On receiving such a RAM pattern request signal 410, a CPU returns the RAM pattern notice signal 420 shown in FIG. 10.

A port pattern request signal 440 shown in FIG. 19 is a signal to selectively request a pattern condition corresponding to a condition on an input-output port from among pattern conditions. On receiving such a port pattern request signal 440, a CPU returns the port pattern notice signal 430 shown in FIG. 11.

The operator decides what external detection condition is newly set for the vehicle and determines whether the external detection condition is recorded in the acquired pattern condition (step 930). For a CPU in which the external detection condition is recorded in the pattern condition, the pattern condition signal of a pattern number paired with the external detection condition is transmitted to the CPU (step 940). For a CPU in which the external detection condition is not recorded in the pattern condition, a signal for arbitrary trigger timing setting corresponding to the external detection condition, a RAM condition signal or port condition signal is transmitted to the CPU (step 950). This processing is performed each time the operator decides a new external detection condition.

To determine whether an external detection condition set by the above processing is satisfied by a CPU in the vehicle system 100, the operator uses the management center 250 or the vehicle diagnostic apparatus 280 to transmit a signal to request freeze data to the CPU (step 960). When the freeze data has been transmitted from the CPU, the freeze data is analyzed to find the cause of the abnormal state (step 970).

### Fourth Embodiment

The following describes a fourth embodiment of the present invention. In this embodiment, the ECUs 1-4 described in the first embodiment store freeze data in cooperation with each other in addition to the functions of the first embodiment.

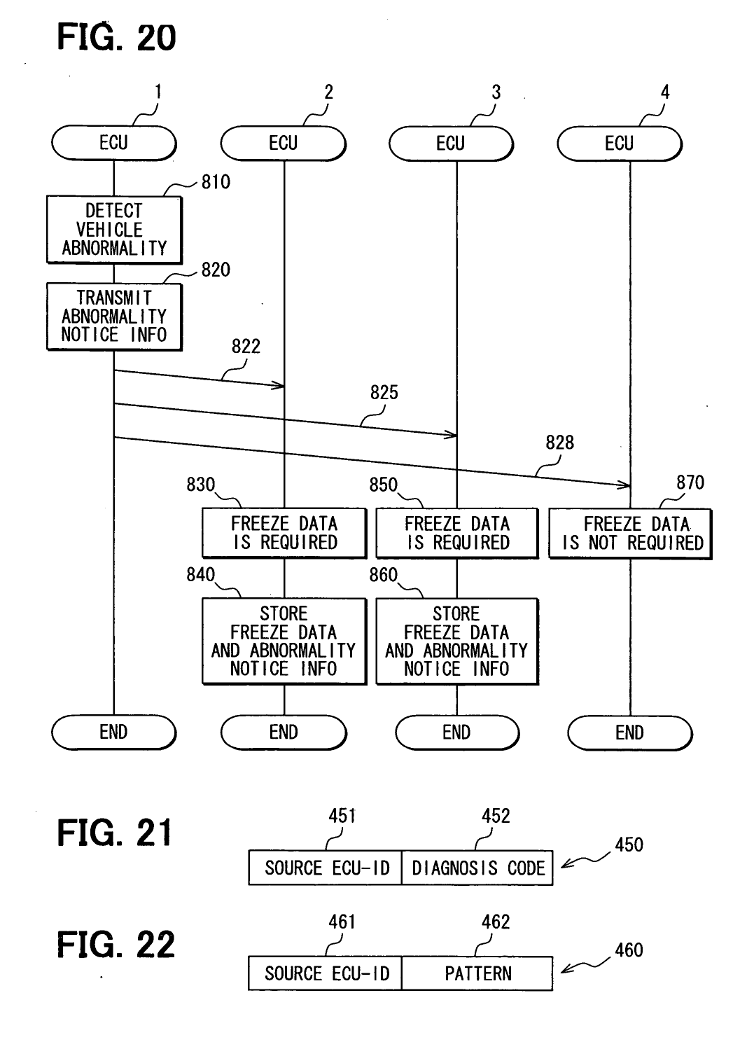

FIG. 20 shows the respective operations of ECUs 1-4 during recording of freeze data in cooperation and the correlation among the operations. Although, in this drawing, the first abnormal state is detected in the ECU 1, the first abnormal state may be detected in any of the ECUs 2-4. One CPU in the ECU 1 detects a vehicle abnormality and stores freeze data (step 810). A method for detecting a vehicle abnormality may be any of a method for detecting abnormality in predetermined conditions as shown in the first embodiment, and a method for detecting abnormality in external conditions set by the trigger setting process 17b.

The CPU of the ECU 1 transmits abnormality notice information to CPUs of other ECUs 2-4 (step 820). Examples of an abnormality notice signal indicating the abnormality notice information are in FIGS. 21 and 22. An abnormality notice signal 450 shown in FIG. 21, which corresponds to abnormality notice information transmitted when abnormality is detected by the abnormality determining unit 16, includes a notice source ECU-ID field 451 and a diagnosis code field 452. The notice source ECU-ID field 451 contains the ID of the ECU 1, and the diagnosis code field 452 contains a diagnosis code outputted together with the detection of abnormality by the abnormality determining unit 16 at step 810.

An abnormality notice signal 460 shown in FIG. 22, which corresponds to abnormality notice information transmitted when abnormality is detected by an external detection condition set by the trigger setting process 17b, includes the same notice source ECU-ID field 461 as the above-described notice source ECU-ID field 451, and a pattern number field 462. The pattern number field 462 contains a pattern number stored as a pattern condition together with an external detection condition used for anomaly detection at step 810.

On receiving the abnormality notice signals (822, 825, 828), the CPUs of the ECUs 2-4 respectively determines whether to store freeze data, based on the contents of the abnormality notice signals (steps 830, 850, 870). Specifically, when a pattern number field 462 is contained in abnormality notice information, the CPUs determine that the freeze data must be stored. When the diagnosis code field 452 is contained in the abnormality notice signals, the CPUs determine whether to record freeze data, based on the value of the diagnosis code in the diagnosis code field 452. For example, if each CPU stores a list of diagnosis codes related to an ECU to which it belongs, and diagnosis code in the received abnormality notice signals is within the list, the CPU determines that freeze data must be stored, and otherwise the CPU determines that it is not necessary to store the freeze data.

In FIG. 20, the CPUs of the ECUs 2, 3 determine that freeze data must be stored, and the CPU of the ECU 4 determines that it is not necessary to store freeze data. On determining that freeze data must be stored, the CPU executes the freeze process 17a to store a pair of freeze data and diagnosis code or pattern number in the received abnormality notice signal (steps 840 and 860). CPUs that determine that it is not necessary to store freeze data do not store the freeze data. By such cooperative operations of the CPUs of the ECUs 1-4, when abnormality is detected in a certain CPU, freeze data is stored not only in that CPU but also in CPUs of other ECUs. Thus, when abnormality is detected in one CPU (or ECU) in the vehicle, each of other CPUs (or ECUs) in the vehicle stores the abnormality notice information together with freeze data when the each of other CPUs determines that abnormality notice information transmitted from the CPU (or ECU) that detects the abnormality is related to itself. Therefore, of CPUs (or ECUs) in the vehicle, CPUs (or ECUs) related to the detected abnormality can store the freeze data at the same time, and further the relativity between the plural pieces of the freeze data is secured by the identity of abnormal notice information stored together with the freeze data.

In the above-described embodiments, the ECU 1 corresponds to an example of an on-vehicle data collection apparatus. Further, the ECU 1 corresponds to an example of a first on-vehicle communication device. The ECUs 2-4 correspond to an example of plural second on-vehicle communication devices. The management center 250 corresponds to an example of a center. The communication data processor 11 corresponds to an example of a communication device. The standby RAM 14 corresponds to an example of a first storage medium. The RAM 12 corresponds to an example of a second storage medium. The EEPROM 1d corresponds to an example of a third storage medium. The I/O port group 13 corresponds to an example of plural input and output ports. The control unit 17 functions as an example of a freeze device by executing the freeze process 17a, and functions as an example of a setting device by executing the trigger setting process 17b. Each of the determination conditions in steps 615, 620, 331, 332, 333 corresponds to an example of the second condition.

The CPU 254 of the management center 250 functions as an example of plural vehicle abnormality recording devices by executing step 710, and functions as an example of an abnormality frequency determining device by executing step 715, and functions as an example of a condition signal transmitting device by executing step 720. The vehicle destination DB 253b corresponds to an example of a correspondence relationship storage medium.

(Modifications)

The embodiments described above may be modified in various ways. For example, the I/O port group 13 may mediate, of signal output to actuators within the vehicle and signal input from sensors within the vehicle, in only the output, or only the input.

In the above-described embodiments, when a pattern number in a received pattern condition signal matches a stored pattern number, a trigger part corresponding to the pattern number is set as an external detection condition. Alternatively, not only when a pattern number in a received pattern condition signal matches a stored pattern number, but also when the logical values of a received pattern number and a stored pattern number are a predetermined value, or when a received pattern number and a stored pattern number are in the relationship between secret key and public key in cipher in the public key system, a trigger part corresponding to the stored pattern number may be set as an external detection condition. That is, when a received pattern number and a stored pattern number correspond, a trigger part corresponding to the stored pattern number may be set as an external detection condition.

The ECU 1 may transmit an external detection condition set by a condition signal from the management center 250 (corresponding to an example of a first device) to the vehicle diagnostic apparatus 280 when a specific request signal is sent from the vehicle diagnostic apparatus 280 (corresponding to an example of a third device). By this construction, an external detection condition set by the management center 250 can be referred to from the vehicle diagnostic apparatus 280, for example, at a vehicle dealer.

A first storage medium and a third storage medium in claims may be one storage medium to cover different addresses of the storage media. A target storage medium to set external detection conditions may be the RAM 12 or the standby RAM 14 instead of the EEPROM 1d. The ECUs 1-4 of the fourth embodiment may not necessarily have the function of the trigger setting process 17b of the first embodiment. In this case, the abnormality detection at step 810 is performed by only the abnormality determining unit 16. When an ignition of the vehicle is turned off, data of a trigger part in a trigger timing setting area may be erased, or data of a pattern condition may be erased.

In the freeze process 17a, the control unit 17 may switch the target of data stored in the standby RAM 14 as freeze data between at failure detection by the failure determining unit 16 and at abnormality detection time by external detection conditions. A trigger part in a condition signal may not necessarily be a condition for detecting abnormality but may be used as a condition for detecting a state in which, for example, information necessary to perform some performance evaluation is generated.

The abnormality determining unit 16 and the control unit 17 may implement their respective functions with different circuit constructions, as shown in FIG. 2, or implement their respective functions by executing different programs with an identical circuit construction. The CPUs of the ECUs 1-4 may not have the abnormality determining unit 16. That is, in each CPU, all abnormality criteria may be set or made changeable from outside the vehicle.

Such changes and modifications are to be understood as being within the scope of the present invention as defined by the appended claims.

What is claimed is:

1. A data collection apparatus mounted on a vehicle comprising:
a communication device configured to communicate with a first external apparatus located outside the vehicle;
a first storage medium configured to hold data stored therein even after power supply to the data collection apparatus from outside the data collection apparatus is interrupted;
a setting device configured to receive a condition signal from the first external apparatus through the communication device and configured to set a first condition contained in the condition signal as a detection condition to detect abnormality of the vehicle; and
a freeze device configured to determine whether the detection condition is satisfied,
wherein the freeze device stores at least one of vehicle control data and vehicle behavior data in the first storage medium as freeze data upon satisfaction of the detection condition.

2. The data collection apparatus according to claim 1, further comprising:
a second memory medium configured to be a random access memory,
wherein the detection condition defines a relationship between a value stored in a predetermined address of the second memory medium and a predetermined reference value.

3. The data collection apparatus according to claim 1, further comprising:
a plurality of input and output ports through which at least one of a signal output to an actuator of the vehicle, a signal input from a sensor of the vehicle, and a signal input from the actuator is performed,
wherein the detection condition defines a relationship between a signal level at a predetermined port of the plurality of input and output ports and a predetermined reference level.

4. The data collection apparatus according to claim 1,
wherein the setting device is configured to disable the detection condition,
wherein the setting device stores the detection condition together with a first identification code having data length less than data length of the detection condition,
wherein the setting device receives a second identification code from the first external apparatus through the communication device and determines whether the first and second identification codes correspond to each other, and
wherein the setting device enables the disabled detection condition upon determination that the first and second identification codes correspond to each other.

5. The data collection apparatus according to claim 4, further comprising:
a third storage medium configured to hold data stored therein even after power supply to the data collection apparatus from outside the data collection apparatus is interrupted,
wherein the setting device stores the detection condition in the third storage medium.

6. The data collection apparatus according to claim 4, further comprising:
a first device configured to receive a request signal through the communication device from a second external apparatus (250, 280) located outside the vehicle,
wherein the first device transmits through the communication device a pair of the detection condition and the first identification code to the second external apparatus upon reception of the request signal.

7. The data collection apparatus according to claim 1,
wherein the setting device determines whether a second condition is satisfied and is prohibited from setting the first condition as the detection condition upon satisfaction of the second condition.

8. The data collection apparatus according to claim 1,
wherein the setting device determines whether a second condition is satisfied and is prohibited from setting the first condition as the detection condition upon satisfaction of the second condition,
wherein the setting device transmits through the communication device a response signal to the first external apparatus upon satisfaction of the second condition, and
wherein the response signal indicates that the first condition is prohibited from being set as the detection condition.

9. The data collection apparatus according to claim 1,
wherein the setting device sets an update cycle contained in the condition signal to the freeze device, and
wherein the freeze device repeatedly determines whether the detection condition is satisfied in the update cycle and stores at least one of the vehicle control data and the vehicle behavior data in the first storage medium as the freeze data upon satisfaction of the detection condition.

10. The data collection apparatus according to claim 1, further comprising:
a second device configured to receive a request signal through the communication device from a third external apparatus located outside the vehicle,
wherein the second device transmits through the communication device the detection condition to the third external apparatus upon reception of the request signal.

11. A center comprising:
a communication interface configured to communicate with a plurality of data collection apparatus, each data collection apparatus being defined in claim 1;
an abnormality recording device configured to record a vehicle identification information and vehicle failure information for each vehicle equipped with the data collection apparatus;
an abnormality frequency determining device configured to determine a group of the same type of vehicles based on the vehicle identification information and configured to determine whether there is a failure type occurring in a larger number of vehicles than a reference occurrence rate in the group, based on the vehicle failure information;
a correspondence relationship storage medium configured to store correspondence data between the data collection apparatus and the vehicle identification information of the vehicle equipped with the data collection apparatus; and
a condition signal transmitting device configured to determine the data collection apparatus mounted to the vehicles belonging to the group based on the correspondence data and configured to transmit same condition signals to the data collection apparatus upon determination that there is the failure type occurring in a larger number of vehicles than the reference occurrence rate.

12. The center according to claim 11,
wherein the vehicle identification information includes a first identification number uniquely identifying the vehicle, a second identification number uniquely identifying the data collection apparatus mounted to the vehicle identified by the first identification number, and an third identification number uniquely identifying at least one of a sensor and an actuator coupled to the data collection apparatus identified by the second identification number.

13. A system mounted on a vehicle comprising:
a first communication apparatus configured to detect abnormality of the vehicle and coupled to an in-vehicle communication network, and
a plurality of second communication apparatus, each second communication apparatus coupled to the network and configured to communicate with the first communication apparatus through the network,
wherein the first communication apparatus transmits abnormality notice information indicative of the detected abnormality over the network upon detection of the abnormality,
wherein each second communication apparatus receives the abnormality notice information and determines whether the abnormality notice information is related to itself based on predetermined information,
wherein each second communication apparatus stores the abnormality notice information together with at least one of vehicle control data and vehicle behavior data as freeze data in a storage medium upon determination that the abnormality notice information is related to itself, and
wherein the storage medium holds data stored therein even after power supply to the system from outside the system is interrupted.

14. The system according to claim 13,
wherein the abnormality notice information is a diagnosis code.

15. The system according to claim 13,
wherein the first communication apparatus comprising:
a communication device configured to communicate with a first external apparatus located outside the vehicle;
a first storage medium configured to hold data stored therein even after power supply to the first communication apparatus from outside the first communication apparatus is interrupted;
a setting device configured to receive a condition signal from the first external apparatus through the communication device and configured to set a first condition contained in the condition signal as a detection condition to detect abnormality of the vehicle; and
a freeze device configured to determine whether the detection condition is satisfied,
wherein the freeze device stores at least one of vehicle control data and vehicle behavior data in the first storage medium as freeze data upon satisfaction of the detection condition,
wherein the setting device is configured to disable the detection condition,
wherein the setting device stores the detection condition together with a first identification code having data length less than data length of the detection condition,
wherein the setting device receives a second identification code from the first external apparatus through the communication device and determines whether the first and second identification codes correspond to each other,
wherein the setting device enables the detection condition upon determination that the first and second identification codes correspond to each other, and
wherein the setting device determines whether the detection condition is satisfied and transmits the first identification code as the abnormality notice information upon satisfaction of the detection condition.
